(19) United States
(12) Patent Application Publication
(10) Pub. No.: US 2006/0184339 A1
(43) Pub. Date: Aug. 17, 2006

(54) Using arm correlators to link log file statements to transaction instances and dynamically adjusting log levels in response to threshold violations

(75) Inventors: Bret Patterson, Cedar Park, TX (US); John R. Rowland, Coupland, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/060,605

(22) Filed: Feb. 17, 2005

(51) Int. Cl. G21C 17/00

(52) U.S. Cl. 702/182

(57) ABSTRACT

A method, apparatus and computer instructions are provided for additional logging capabilities in response to a threshold being violated. Parent and current correlators are utilized as fields in all log files. The correlator field logging service/format advantageously uses the exact log statements to link to a node in the TMTP transaction decomposition topology. The TMTP violation flag is used to dynamically increase the log levels. The TMTP violation flag is initiated in response to an ARM threshold violation.

### BACKGROUND OF THE INVENTION

1. Technical Field

The present invention relates to monitoring and correlating transactions within log files. Particularly, the present invention provides a method of dynamically adjusting log levels in response to threshold violations.

2. Description of Related Art

Monitoring and correlating transactions is an excellent way to provide detailed performance statistics and a high level view of where errors occur. One example of a monitoring and correlating system is the IBM Tivoli® Monitoring for Transaction Performance software which is a centrally managed suite of software components that monitor the availability and performance of Web-based services and Microsoft Windows® applications. IBM Tivoli® Monitoring for Transaction Performance captures detailed performance data for all e-business transactions. The software may be used to perform the following e-business management tasks:
Monitor every step of an actual customer transaction as it passes through a complex array of hosts, systems, and applications: Web and proxy servers, Web application servers, database management systems, and legacy back-office systems and applications.
Simulate customer transactions, collecting performance data that helps in assessing the health of e-business components and configurations.
Consult comprehensive real-time reports that display recently collected data in a variety of formats and from a variety of perspectives. Integrate with the IBM Tivoli® Data Warehouse, where collected data may be stored for use in historical analysis and long-term planning.
Receive prompt, automated notification of performance problems, which provides accurate measurements of how users experience your Web site and applications under different conditions and at different times. Most importantly, performance problems may be isolated at the source as they occur, so that the problems may be corrected before they produce expensive outages and lost revenue.

Applications may use IBM Tivoli® Monitoring for Transaction Performance to measure transaction response times through the IBM Tivoli® Application Response Measurement (ARM) Application Program Interface (API). In order to use ARM, applications must be modified to call the ARM API at the defined business transaction boundaries. ARM instrumented applications may use the IBM Tivoli® Monitoring for Transaction Performance console to visualize transaction topology, define thresholds for transactions, and receive alerts when transaction thresholds are violated.

Integrated applications may take advantage of the following major components that may be used to investigate and monitor transactions:
Discovery component allows identification of incoming Web transactions that need to be monitored.
Listening components are the quality of service and J2EE monitoring components that collect data for actual user transactions that are executed against the Web servers and Web applications servers.
Playback components are synthetic transaction investigator and Rational robot/generic Windows that robotically execute, or playback, transactions that are recorded in order to simulate actual user activity.

Although the IBM Tivoli® Monitoring for Transaction Performance captures detailed performance data for all e-business transactions, a problem may exist in that the log files provide only a general idea of how to solve the problem. The extensive log files that are created for the e-business transactions require an extensive review of all of the logged transactions and the related code to determine where and when an error occurs and what part of the code caused the error. This operation may be time consuming and possibly prone to further error. Thus, providing additional trace logs or log statements would assist in determining the location and time of the transaction instance where the error occurred, and, in turn, the related portion of code that was accessed during the transaction.

### SUMMARY OF THE INVENTION

The present invention provides a method, apparatus and computer instructions for additional logging capabilities in response to a threshold being violated. The exemplary aspects of the present invention utilize a parent and current correlator as a field in all log files. By making use of this logging service/format, the present invention advantageously uses the exact log statements to link to a node in the TMTP transaction decomposition topology. Additionally, the present invention makes use of a TMTP violation flag to dynamically increase the log levels. The TMTP violation flag is initiated in response to an ARM threshold violation.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram of a data processing system in which the present invention may be implemented;

FIG. 4 is a block diagram of a data processing system where an application processed a transaction in which the present invention may be implemented;

FIGS. 5A is a block diagram of a data processing system in which a servlet processes a transaction in accordance with a preferred embodiment of the present invention;

FIG. 5B is a block diagram of a data processing system in which a (JDBC) processes a transaction in accordance with a preferred embodiment of the present invention;

FIGS. 6A-6B are a flow diagram illustrating an exemplary operation of logging call and statement transactions in accordance with a preferred embodiment of the present invention; and

FIG. 7 is a table of requests that are used in conjunction with the exemplary flow diagram shown in FIGS. 6A-6B.

### DETAILED DESCRIPTION OF THE PREFERRED EMBODIMENT

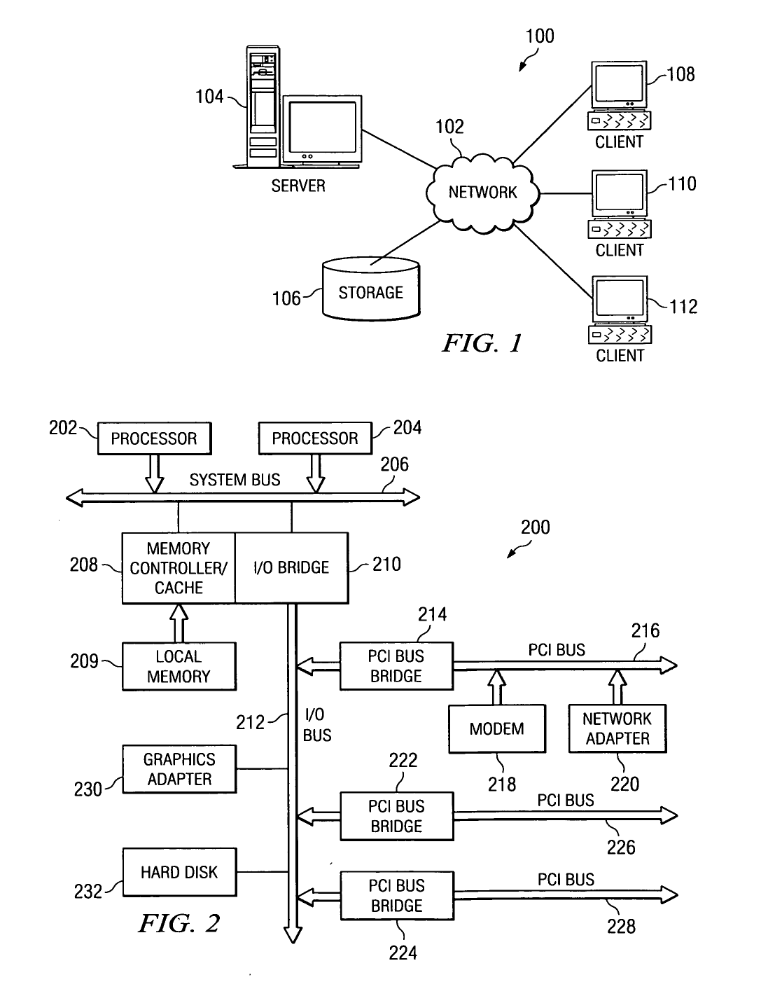

The present invention provides a method, apparatus and computer instructions for additional logging capabilities in response to a threshold being violated. The data processing device may be a stand-alone computing device or may be a distributed data processing system in which multiple computing devices are utilized to perform various aspects of the present invention. Therefore, the following FIGS. 1-3 are provided as exemplary diagrams of data processing environments in which the present invention may be implemented. It should be appreciated that FIGS. 1-3 are only exemplary and are not intended to assert or imply any limitation with regard to the environments in which the present invention may be implemented. Many modifications to the depicted environments may be made without departing from the spirit and scope of the present invention.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables. In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In accordance with a preferred embodiment of the present invention, server 104 provides application integration tools to application developers for applications that are used on clients 108, 110, 112. More particularly, server 104 may provide access to application integration tools that will allow two different front-end applications in two different formats to disseminate messages sent from each other.

In accordance with one preferred embodiment, a dynamic framework is provided for using a graphical user interface (GUI) for configuring business system management software. This framework involves the development of user interface (UI) components for business elements in the configuration of the business system management software, which may exist on storage 106. This framework may be provided through an editor mechanism on server 104 in the depicted example. The UI components and business elements may be accessed, for example, using a browser client application on one of clients 108, 110, 112.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eserver™ pseries® system, a product of International Business Machines Corporation in Armonk, N.Y., running the Advanced Interactive Executive (AIX™) operating system or LINUX operating system.

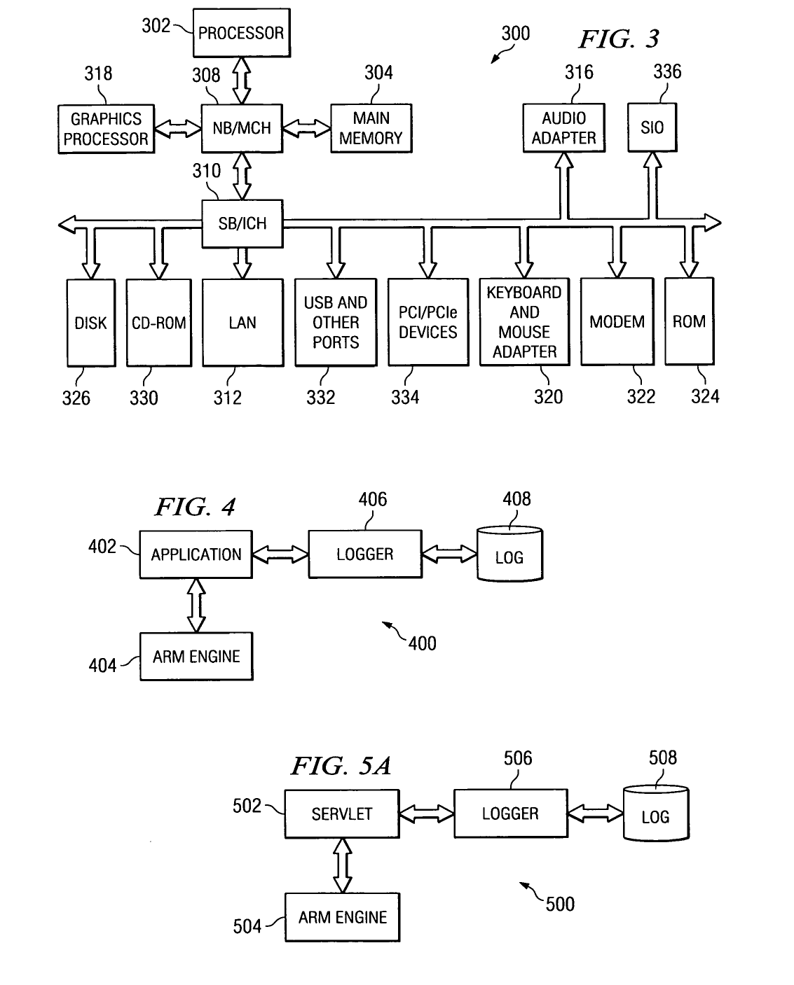

With reference now to FIG. 3, a block diagram of a data processing system is shown in which the present invention may be implemented. Data processing system 300 is an example of a computer, such as client 108 in FIG. 1, in which code or instructions implementing the processes of the present invention may be located. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, local area network (LAN) adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 may be connected to ICH 310. PCI/PCIe devices may include, for example, Ethernet adapters, add-in cards, PC cards for notebook computers, etc. PCI uses a cardbus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and is used to coordinate and provide control of various components within data processing system 300 in FIG. 3. The operating system may be a commercially available operating system such as Windows XP™, which is available from Microsoft Corporation. An object oriented programming system, such as the Java™ programming system, may run in conjunction with the operating system and provides calls to the operating system from Java™ programs or applications executing on data processing system 300. “JAVA” is a trademark of Sun Microsystems, Inc.

Instructions for the operating system, the object-oriented programming system, and applications or programs are located on storage devices, such as hard disk drive 326, and may be loaded into main memory 304 for execution by processor 302. The processes of the present invention are performed by processor 302 using computer implemented instructions, which may be located in a memory such as, for example, main memory 304, memory 324, or in one or more peripheral devices 326 and 330.

Those of ordinary skill in the art will appreciate that the hardware in FIG. 3 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the present invention may be applied to a multiprocessor data processing system.

For example, data processing system 300 may be a personal digital assistant (PDA), which is configured with flash memory to provide non-volatile memory for storing operating system files and/or user-generated data. The depicted example in FIG. 3 and above-described examples are not meant to imply architectural limitations. For example, data processing system 300 also may be a tablet computer, laptop computer, or telephone device in addition to taking the form of a PDA.

With reference now to FIG. 4, a block diagram of a data processing system 400 is shown in which the present invention may be implemented. In exemplary data processing system 400, an ARM Start Call is sent from application 402 to ARM Engine 404. ARM Engine 404 responds to the ARM Start Call from application 402 with a correlator if a threshold is violated and logging should be temporarily raised for a specific transaction topology instance that will be used in the application operation. Possible application defined log levels may be DEBUG_MIN, DEBUG_MED and DEBUG_MAX which indicates the log level at which the transaction topology instance should be logged. Additionally, if a Violation Bit passed in the correlator indicates increased logging levels then the logger may override the current logging levels and temporarily allow logging to be increased for specific transaction topology instances, in this case statement transactions related to this transaction topology instance. Then, throughout the application, operation logger 406 either logs statement transactions to log 408 or ignores statement transactions, depending on the indicated transaction logging level or Violation Bit setting. While statement transactions are used in the various examples of the present invention, any type of transaction may be defined.

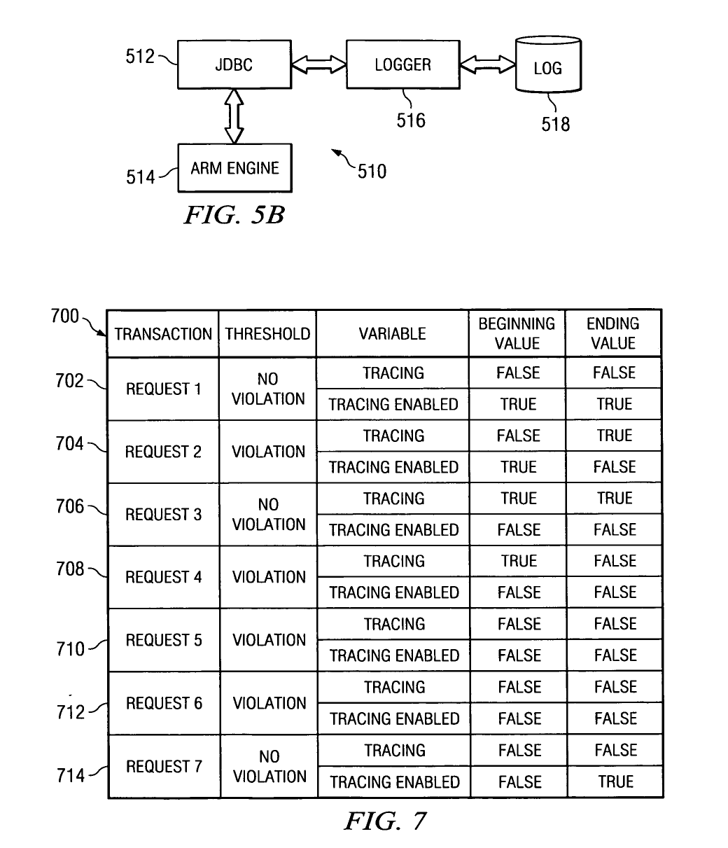

Turning now to FIG. 5A, a block diagram of a data processing system 500 is shown in which a servlet processes a transaction in accordance with a preferred embodiment of the present invention. In this exemplary operation, a user indicates the desire to purchase a product by sending a request to servlet 502. Servlet 502 then initiates an ARM Start Call to ARM Engine 504. ARM Engine 504 responds to the ARM Start Call from servlet 502 with a correlator which may include a Violation Bit that the application's logger 506 may use to override the current log level. Once the correlator is received, servlet 502 makes a Method Execution Call producing a statement transaction. If the correlator sent by ARM Engine 504 includes a Violation Bit which indicates a default log override, then statement transactions are logged by logger 506 to the log file 508, otherwise the statement transactions are logged with the applications current default logging rules.

Turning now to FIG. 5B, a block diagram of a data processing system 510 is shown in which a Java™ Database Connectivity (JDBC) interface 512 processes a transaction in accordance with a preferred embodiment of the present invention. In this exemplary operation, in order to verify whether the product is actually in stock the servlet 502 initiates of one of the methods of JDBC interface 512. In this example, an ARM Start Call is sent to ARM Engine 514. ARM Engine 514 responds to the ARM Start Call from the JDBC interface 512 with a correlator which may include a Violation Bit that the application's logger 516 may use to override the current log level. Once the correlator is received, servlet 502 initiates another one of the methods of JDBC interface 512. In this example, a Method Execution Call producing a statement transaction. If the correlator sent by ARM Engine 514 includes a Violation Bit which indicates a default log override, then statement transactions are logged by logger 516 to the log file 518, otherwise the statement transactions are logged with the applications current default logging rules.

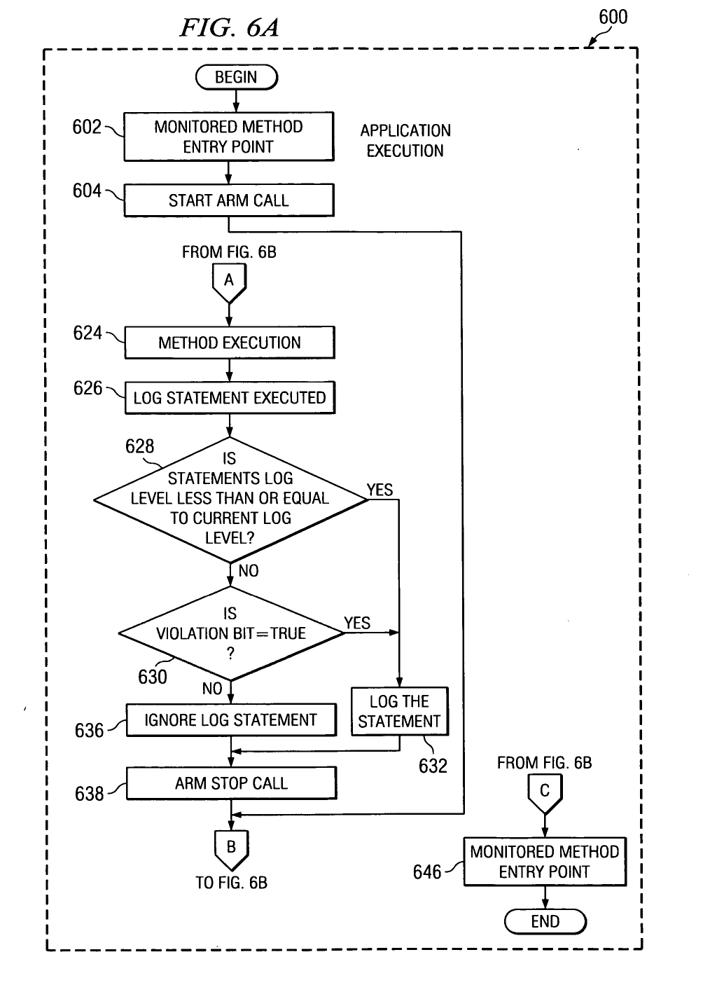

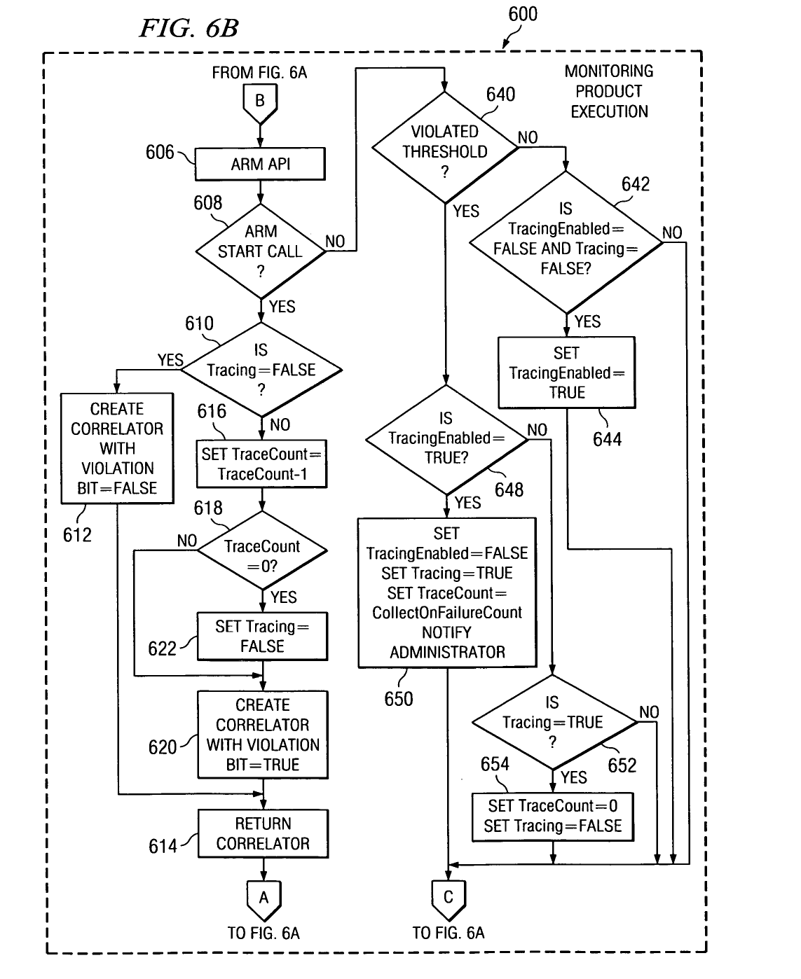

In FIGS. 6A-6B, a flow diagram 600 illustrating an exemplary operation of logging statement transactions is depicted in accordance with a preferred embodiment of the present invention. As the operation begins the execution of a transaction in an application provides a point for entry into the method being monitored through a Monitored Method Entry Point (block 602). Then an ARM Start Call (block 604) is sent to an ARM API (block 606) of a monitoring product to retrieve the logging level for the transaction. The ARM API verifies if the call received is an ARM Start Call or an ARM Stop Call (block 608). If the call is an ARM Start Call, a determination is made as to the value of a Tracing variable within the ARM Start Call (block 610). If the value of the Tracing variable is FALSE, then a correlator is created with a Violation Bit variable set to FALSE (block 612). The correlator is returned to the application (block 614).

Returning to block 610, if the value of the Tracing variable is TRUE, then the value of a TraceCount variable is set to the value of TraceCount variable minus 1 (block 616). The TraceCount variable may not be a negative number. A determination of the value of TraceCount variable is made as to whether the value is equal to 0 (block 618). If the value of the TraceCount variable is not 0, then a correlator is created with a Violation Bit variable set to TRUE (block 620) and the correlator is returned to the application (block 614). Returning to block 618, if the value of the TraceCount variable is equal to 0, then the Tracing variable is set to FALSE (block 622). Then a correlator is created with a Violation Bit variable set to TRUE (block 620) and the correlator is returned to the application (block 614).

At block 624, the method is executed using the correlator information returned at block 614. Statement logging is executed (block 626) and a determination is made as to whether the statements log level is less than or equal to the current (system default) log level (block 628). If the statements log level is less than or equal to the current log level, then the statements transmitted by the transaction are logged (block 632). If the statements log level is more than the current log level, then a determination is made to determine the value of the Violation Bit (block 630). If the Violation Bit value is TRUE, then the statements transmitted by the transaction are logged (block 632). If the Violation Bit value is FALSE, then the statements transmitted by the transaction are ignored (block 636). After the transaction is completed an ARM Stop Call is sent (block 638) to the ARM API (block 606).

The ARM API verifies if the call received is an ARM Start Call or an ARM Stop Call (block 608). Since the call is an ARM Stop Call, the operation proceeds to block 640 where a determination is made as to whether a parameter is violated. The parameter of this example is whether the transaction time violates a threshold. If the threshold is not violated, then a check is made as to whether a TracingEnabled variable is set to FALSE and the Tracing variable is also set to FALSE (block 642). If both variables are not set to FALSE, then the operation proceeds to the Monitored Method Exit Point (block 646) with the operation ending thereafter. If at block 642, both of the variables are set to FALSE, then the TracingEnabled variable is set to TRUE (block 644) and the operation proceeds to the Monitored Method Exit Point (block 646) with the operation ending thereafter.

Returning to block 640, if the threshold is violated, then a determination is made as to the value of the TracingEnabled variable (block 648). If the TracingEnabled variable is TRUE, then the value of the TracingEnabled variable is set to FALSE, the value of the Tracing variable is set to TRUE, the value of the TraceCount variable is set to a CollectOnFailureCount value, which corresponds to a number of transactions that are intended to be captured, whether violating or non-violating, and a system administrator is notified (block 650). Then the operation proceeds to the Monitored Method Exit Point (block 646) with the operation ending thereafter.

Returning to block 648, if the TracingEnabled variable is not set to TRUE, then a determination is made as to the value of the Tracing variable (block 652). If the Tracing variable value is TRUE, then the TraceCount variable is set to 0 and the Tracing variable is set to FALSE (block 654). Then the operation proceeds to the Monitored Method Exit Point (block 646) with the operation ending thereafter. Returning to block 652, if the value of the tracing variable is not TRUE, then the operation proceeds to the Monitored Method Exit Point (block 646) with the operation ending thereafter.

An example of this operation is provided using the requests shown in Table 700 of FIG. 7. In this exemplary operation, a user indicates the desire to purchase a product (request 702). Additionally, the default values of the variables used at the start of these exemplary operation are Tracing=FALSE, TracingEnabled=TRUE, and TraceCount=0. With the user indication, a Monitored Method Entry Point is performed by the application (block 602). The Monitored Method Entry Point initiates an ARM Start Call (block 604). The ARM API receives the ARM Start Call (block 606) and a determination is made as to whether the call is an ARM Start Call (block 608). Since the call is an ARM Start Call, a determination is made as to the value of a Tracing variable within the ARM Start Call (block 610). Since the default value of the Tracing variable is FALSE, a correlator is created with a Violation Bit variable set to FALSE (block 612) and the correlator is returned to the application (block 614).

At block 624, the method is executed using the correlator information returned at block 614. Statement logging is executed (block 626) and a determination is made as to whether the statements log level is less than or equal to the current (system default) log level (block 628). Assuming the statements log level is more than the current log level (block 628), then a determination is made to determine the value of the Violation Bit (block 630). Since the Violation Bit value is FALSE, the statements transmitted by the transaction are ignored (block 636). After the transaction is completed an ARM Stop Call is sent (block 638) to the ARM API (block 606).

The ARM API verifies that the received call is an ARM Stop Call (block 608) and the operation proceeds to block 640 where a determination is made as to whether the transaction time parameter violates a threshold. In request 702, there is not a violation of the time threshold. A check is made as to whether a TracingEnabled variable is set to FALSE and the Tracing variable is also set to FALSE (block 642). Since the default value of the TracingEnabled variable is TRUE and the Tracing variable is FALSE as determined at block 610, the operation proceeds to the Monitored Method Exit Point (block 646) with the operation ending thereafter. Thus, the beginning and ending values of the Tracing and TracingEnabled variables are the same. That is, value of Tracing is set to FALSE and TracingEnabled is set to TRUE.

The operation with respect to request 704 is similar to that of request 702 up to the determination at block 640 where a threshold violation occurs due to the time it took to complete the transaction. In request 704, since the threshold is violated and a check is made as to the value of the TracingEnabled variable (block 648), which is TRUE as shown at the end of request 702. The operation proceeds to block 650, where the value of the TracingEnable variable is set to FALSE, the value of the Tracing variable is set to TRUE, the value of the TraceCount variable is set to a CollectOnFailureCount value, for this exemplary operation a value of 10, and a system administrator is notified. Then the operation proceeds to the Monitored Method Exit Point (block 646) with the operation ending thereafter. Thus, at the end of request 704 the ending value of Tracing is set to TRUE and TracingEnabled is set to FALSE.

Proceeding with request 706, a user indication causes a Monitored Method Entry Point to be performed by the application (block 602). The Monitored Method Entry Point initiates an ARM Start Call (block 604). The ARM API receives the ARM Start Call (block 606) and a determination is made as to whether the call is an ARM Start Call (block 608). Since the call is an ARM Start Call, a determination is made as to the value of a Tracing variable within the ARM Start Call (block 610). Since the value of the Tracing variable is now TRUE, then the value of a TraceCount variable is set to the value of TraceCount variable minus 1 which would now be 9 from the value set in the previous request (block 616). A determination of the value of TraceCount variable is made as to whether the value is equal to 0 (block 618). Since the value of the TraceCount variable is not 0, then a correlator is created with a Violation Bit variable set to TRUE (block 620) and the correlator is returned to the application (block 614).

At block 624, the method is executed using the correlator information returned at block 614. Statement logging is executed (block 626) and a determination is made as to whether the statements log level is less than or equal to the current (system default) log level (block 628). Assuming the statements log level is more than the current log level (block 628), a determination is made to determine the value of the Violation Bit (block 630). With respect to request 706, the Violation Bit has been set to TRUE at block 620, thus at block 630 the operation proceeds to block 632. At block 632, the statements transmitted by the transaction are logged. After the transaction is completed an ARM Stop Call is sent (block 638) to the ARM API (block 606).

The ARM API verifies that the received call is an ARM Stop Call (block 608) and the operation proceeds to block 640 where a determination is made as to whether the transaction time parameter violates a threshold. In request 706, there is not a violation of the time threshold. A check is made as to whether a TracingEnabled variable is set to FALSE and the Tracing variable is also set to FALSE (block 642). Since the value of the TracingEnabled variable is now FALSE and the Tracing variable is now TRUE, the operation proceeds to the Monitored Method Exit Point (block 646) with the operation ending thereafter. Thus, at the end of request 706 the ending value of Tracing is set to TRUE and TracingEnabled is set to FALSE.

Proceeding with request 708, a user indication causes a Monitored Method Entry Point to be performed by the application (block 602). The Monitored Method Entry Point initiates an ARM Start Call (block 604). The ARM API receives the ARM Start Call (block 606) and a determination is made as to whether the call is an ARM Start Call (block 608). Since the call is an ARM Start Call, a determination is made as to the value of a Tracing variable within the ARM Start Call (block 610). Since the value of the Tracing variable is now TRUE, then the value of a TraceCount variable is set to the value of TraceCount variable minus 1 which would now be 8 from the value set in the previous request (block 616). A determination of the value of TraceCount variable is made as to whether the value is equal to 0 (block 618). Since the value of the TraceCount variable is not 0, then a correlator is created with a Violation Bit variable set to TRUE (block 620) and the correlator is returned to the application (block 614).

At block 624, the method is executed using the correlator information returned at block 614. Statement logging is executed (block 626) and a determination is made as to whether the statements log level is less than or equal to the current (system default) log level (block 628). Assuming the statements log level is more than the current log level (block 628), a determination is made to determine the value of the Violation Bit (block 630). With respect to request 708, the Violation Bit has been set to TRUE at block 620, thus at block 630 the operation proceeds to block 632. At block 632, the statements transmitted by the transaction are logged. After the transaction is completed an ARM Stop Call is sent (block 638) to the ARM API (block 606).

The ARM API verifies that the received call is an ARM Stop Call (block 608) and the operation proceeds to block 640 where a determination is made as to whether the transaction time parameter violates a threshold. In request 708, there is a violation of the time threshold. In request 708, since the threshold is violated and a check is made as to the value of the TracingEnabled variable (block 648), which is FALSE as shown at the end of request 706. The operation proceed to block 652, where, since the Tracing variable value is TRUE, then the TraceCount variable is set to 0 and the Tracing variable is set to FALSE (block 654). Then the operation proceeds to the Monitored Method Exit Point (block 646) with the operation ending thereafter. Thus, at the end of request 708 the ending value of Tracing is set to FALSE and TracingEnabled is set to FALSE.

Proceeding with request 710, a user indication causes a Monitored Method Entry Point to be performed by the application (block 602). The Monitored Method Entry Point initiates an ARM Start Call (block 604). The ARM API receives the ARM Start Call (block 606) and a determination is made as to whether the call is an ARM Start Call (block 608). Since the call is an ARM Start Call, a determination is made as to the value of a Tracing variable within the ARM Start Call (block 610). Since the default value of the Tracing variable is FALSE, a correlator is created with a Violation Bit variable set to FALSE (block 612) and the correlator is returned to the application (block 614).

At block 624, the method is executed using the correlator information returned at block 614. Statement logging is executed (block 626) and a determination is made as to whether the statements log level is less than or equal to the current (system default) log level (block 628). Assuming the statements log level is more than the current log level (block 628), a determination is made to determine the value of the Violation Bit (block 630). Since the Violation Bit value is FALSE, the statements transmitted by the transaction are ignored (block 636). After the transaction is completed an ARM Stop Call is sent (block 638) to the ARM API (block 606).

The ARM API verifies that the received call is an ARM Stop Call (block 608) and the operation proceeds to block 640 where a determination is made as to whether the transaction time parameter violates a threshold. In request 710, since the threshold is violated, a check is made as to the value of the TracingEnabled variable (block 648), which is FALSE as shown at the end of request 708. The operation proceed to block 652, where, since the Tracing variable value is FALSE, the operation proceeds to the Monitored Method Exit Point (block 646) with the operation ending thereafter. Thus, at the end of request 710 the ending value of Tracing is set to FALSE and TracingEnabled is set to FALSE.

Proceeding with request 712, a user indication causes the operation to proceed in the same manner with respect to request 710. Thus, at the end of request 712 the ending value of Tracing is set to FALSE and TracingEnabled is set to FALSE.

Proceeding with request 714, a user indication causes a Monitored Method Entry Point to be performed by the application (block 602). The Monitored Method Entry Point initiates an ARM Start Call (block 604). The ARM API received the ARM Start Call (block 606) and a determination is made as to whether the call is an ARM Start Call (block 608). Since the call is an ARM Start Call, a determination is made as to the value of a Tracing variable within the ARM Start Call (block 610). Since the default value of the Tracing variable is FALSE, a correlator is created with a Violation Bit variable set to FALSE (block 612) and the correlator is returned to the application (block 614).

At block 624, the method is executed using the correlator information returned at block 614. Statement logging is executed (block 626) and a determination is made as to whether the statements log level is less than or equal to the current (system default) log level (block 628). Assuming the statements log level is more than the current log level (block 628), a determination is made to determine the value of the Violation Bit (block 630). Since the Violation Bit value is FALSE, the statements transmitted by the transaction are ignored (block 636). After the transaction is completed an ARM Stop Call is sent (block 638) to the ARM API (block 606).

The ARM API verifies that the received call is an ARM Stop Call (block 608) and the operation proceeds to block 640 where a determination is made as to whether the transaction time parameter violates a threshold. In request 714, there is not a violation of the time threshold. Then a check is made as to whether a TracingEnabled variable is set to FALSE and the Tracing variable is also set to FALSE (block 642). Since the value of the TracingEnabled variable is now FALSE and the Tracing variable is also FALSE, then the TracingEnabled Variable is set to TRUE (block 644) and the operation proceeds to the Monitored Method Exit Point (block 646) with the operation ending thereafter. Thus, at the end of request 714 the ending value of Tracing is set to FALSE and TracingEnabled is set to TRUE, which are the same as the default values.

The administrator after receiving the notification of a problem from block 650 then requests a transaction and log file roll-up. These files are sent to the TMTP server, which then shows him a graph of the transaction topology. This transaction topology indicates that that the product purchase operation is taking more than one minute and also indicates the specific portion of the query that is causing the problem. The administrator is then able to request the log files associated with that exact query that took so long. Instead of getting just minimal logging, which would normally be provided based on the normal setting for performance reasons, the administrator gets a complete list of every log statement at DEBUG_MAX which allows for a determination of what the problem is.

The main purpose for this operation is that no operation may run with its default logging at the maximum level without serious performance issues. When 10,000 users are accessing a server but only five users are encountering issues, it is invaluable to be able to isolate those five user transactions, and allow the other 9,995 user transactions to continue to operate at low logging level while letting just the ones that are having a problem log at DEBUG_MAX a few times to capture detailed diagnostic information about the scenario that is causing a performance problem.

In summary, the present invention provides a method, apparatus and computer instructions for additional logging capabilities in response to a threshold being violated. By logging the correlator in the log statement the administrator is able to link to the exact log statements with the exact steps in transactions. This way, when a log file is rolled up with transactions, the relevant pieces to the problem scenario may be linked directly to the step in the transaction that the log statement occurred in response to.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for monitoring and correlating transactions, the method comprising:
providing a logging level;
monitoring a transaction for a parameter;
determining if the parameter violates a threshold;
responsive to a threshold violation, setting an indicator, wherein the indicator indicates an override of the logging level; and
logging transactions at an increased logging level responsive to the indicator being set.

2. The method of claim 1, wherein providing the logging level includes:
initiating a call to a measurement application;
responsive to the call, receiving a correlator, wherein the correlator indicates the logging level for transactions.

3. The method of claim 1, wherein the indicator is a violation bit.

4. The method of claim 1, further comprising:
notifying an administrator of the threshold violation.

5. The method of claim 4, further comprising:
passing a roll-up of the transaction logs to an administrator.

6. The method of claim 5, further comprising:
linking the transaction logs to the notification of the threshold violation.

7. The method of claim 1, wherein the measurement application is run using an application program interface.

8. A data processing system comprising:
a bus system;
a communications system connected to the bus system;
a memory connected to the bus system, wherein the memory includes a set of instructions; and
a processing unit connected to the bus system, wherein the processing unit executes the set of instructions to provide a logging level; monitor a transaction for a parameter; determine if the parameter violates a threshold; responsive to a threshold violation, sets an indicator, wherein the indicator indicates an override of the logging level; and logs transactions at an increased logging level responsive to the indicator being set.

9. The data processing system of claim 8, wherein the logging level is provided by the processing unit executing a set of instructions to initiate a call to a measurement application; and responsive to the call, receive a correlator, wherein the correlator indicates the logging level for transactions.

10. The data processing system of claim 8, wherein the indicator is a violation bit.

11. The data processing system of claim 8, further comprising:
a set of instructions to notify an administrator of the threshold violation.

12. The data processing system of claim 11, further comprising:
a set of instructions to pass a roll-up of the transaction logs to an administrator.

13. The data processing system of claim 12, further comprising:
a set of instructions to link the transaction logs to the notification of the threshold violation.

14. The data processing system of claim 9, wherein the measurement application is run using an application program interface.

15. A computer program product in a computer readable medium for monitoring and correlating transactions, the computer program product comprising:
instructions for providing a logging level;
instructions for monitoring a transaction for a parameter;
instructions for determining if the parameter violates a threshold;
responsive to a threshold violation, instructions for setting an indicator, wherein the indicator indicates and override of the logging level; and
instructions for logging transactions at an increased logging level responsive to the indicator being set.

16. The computer program product of claim 15, wherein the instructions for providing the logging level includes:
instructions for initiating a call to a measurement application;
instructions for responsive to the call, receiving a correlator, wherein the correlator indicates the logging level for transactions.

17. The computer program product of claim 15, wherein the indicator is a violation bit.

18. The computer program product of claim 16, further comprising:
instructions for notifying an administrator of the threshold violation.

19. The computer program product of claim 18, further comprising:
instructions for passing a roll-up of the transaction logs to an administrator.

20. The computer program product of claim 19, further comprising:
instructions for linking the transaction logs to the notification of the threshold violation.
